(19) United States
(12) Patent Application Publication
(10) Pub. No.: US 2011/0161064 A1
(43) Pub. Date: Jun. 30, 2011

(54) Physics-based compact model generation from electromagnetic simulation data

(75) Inventors: Ben Song, San Jose, CA (US); Jinsong Zhao, Palo Alto, CA (US)

(73) Assignee: LORENTZ SOLUTION, INC., Santa Clara, CA (US)

(21) Appl. No.: 12/834,712

(22) Filed: Jul. 12, 2010

Related U.S. Application Data
(60) Provisional application No. 61/291,800, filed on Dec. 31, 2009.

(51) Int. Cl. G06F 17/50

(52) U.S. Cl. 703/14

(57) ABSTRACT

Some embodiments of the present invention provide a method of circuit design and circuit simulation. A method for electrical modeling of passive structures of a circuit design wherein the passive structures have DC properties is disclosed. The method comprises constructing a physical topology based on the passive structures of the circuit design, mapping the physical topology to a network of EM modeling elements, and determining parameters of the EM modeling elements to model the passive structures based on electromagnetic simulation data.

### RELATED APPLICATION

The subject matter of this application claims priority from U.S. Provisional Application 61/291,800 entitled “Physics-based Compact Model Generation from EM Simulation Data and the Flexible PBM Modeling Framework”, by inventors Jinsong Zhao and Ben Song, which was filed 12-31-09.

### BACKGROUND

1. Technical Field

This disclosure generally relates to circuit design and simulation. More specifically, this disclosure relates to generation of electromagnetic modeling elements to simulate high speed electrical circuits.

2. Related Art

In today's nanometer RF and high-speed analog IC designs, it is imperative to have both intended effects and parasitic effects thoroughly verified electromagnetically to predict their high-frequency behaviors. Models are then generated using EM data and fed into a circuit simulator for performance check. Critical electrical properties such as passivity, physical realizability, and DC inductance and resistance have to be preserved during the modeling process. An extraction-based approach first extracts a large netlist of frequency-independent RLCK elements and then applies a certain model order reduction method to get a smaller system of DAE (Differential Algebraic Equations). A rational-approximation based approach solves a non-linear least square problem to minimize the error between a prescribed rational model and EM simulation data such as Y- or S-parameters. Both approaches suffer from similar difficulties: first, passivity is computationally very expensive to enforce if not impossible; second, DC inductance and resistance are not preserved; third, the resulting models, even if passive, are usually not physically realizable. Besides, the frequency-independence assumption adopted by extraction-based methods already degrades the accuracy even before the order reduction. What is needed is a methodology to generate physics-based compact model that overcome the shortcomings of previous approaches.

### SUMMARY OF INVENTION

Unlike the aforementioned approaches, the proposed methodology maps the structure under EM simulation to a network of EM modeling elements such as lumped RLCK elements and predefined parameterized sub-circuits which come from an extendable library of basic modeling elements. This mapping process either determines the topology of the network in a systematically automated way or accepts a prescribed topology based on some priori knowledge. Each basic modeling element is designed to capture certain dominant physical effects such as skin-effect or proximity effect. The behavior of the dominant physical effects is determined by a few parameters. An effective optimization strategy is then applied to adjust parameters of all basic modeling elements to meet desired performance targets in the frequency range of interest. Basic modeling elements are so designed that critical DC properties such as DC inductance and DC resistance are maintained throughout the optimization step regardless of the topology of the network, The resulting models are passive and physical realizable by construction. A modeling framework called “Flexible PBM” (PBM stands for Physics-Based Modeling) is also developed to take full advantage of the flexibility inherent in the proposed methodology.

In accordance with an embodiment, the present invention provides a modeling methodology in a circuit design and simulation environment to allow the generation of physics-based, simulator-friendly compact model using results from electromagnetic simulation of passive structures, including passive devices and interconnects. It is recognized that both two existing approaches, extraction-based and rational-approximation based, suffer from difficulties in preserving critical electrical properties while maintaining modeling accuracy over interested frequency range. Unlike the aforementioned approaches, the proposed methodology maps the structure under EM simulation to an equivalent circuit composed of an extendable library of basic modeling elements such as lumped RLCK elements and predefined parameterized sub-circuits. Parameters of all basic modeling elements are adjusted through an optimization strategy to meet desired performance targets with a specified frequency range.

In accordance with an aspect, the present invention solves problems that have plagued others in the circuit simulation filed in their attempts to accurately and efficiently model electrical circuit properties. First, the introduction of an extendable library of basic modeling elements each of which is designed to capture certain electromagnetic effect and maintain critical DC properties under parameter variation; second, a systematic approach to automatically map a generic passive structure to a network of EM modeling elements; third, an intelligent approach to optimize all parameters of EM modeling elements by combining a divide-and-conquer strategy and frequency-continuation scheme; fourth, an intelligent way to identify important performance optimization targets when design intention is not available; and last, a flexible modeling framework which allows customization in both model topology mapping strategy and optimization strategy.

In accordance with another aspect of the present invention, a method for electrical modeling of passive structures of a circuit design is disclosed wherein the passive structures have DC properties. The method comprising the steps of constructing a physical topology based on the passive structures of the circuit design, mapping the physical topology to a network of EM modeling elements, and determining parameters of the EM modeling elements to model the passive structures based on electromagnetic simulation data.

In accordance with other aspects of the present invention, the parameters of the EM modeling elements is determined by using a sequence of optimizations based on the electromagnetic simulation data. The substep of generating an EM-graph comprises one or more islands. The islands are each comprised of paths, polygons, and virtual nodes. The virtual nodes allow probing of auxiliary information during EM simulation to aid the determination step without disturbing the EM simulation data.

In accordance with yet another aspect of the present invention, the step of constructing physical topology includes the substep of applying a set of rules to consolidate the EM-graph and maintain the DC properties of the physical structure for the consolidated EM-graph.

### BRIEF DESCRIPTION OF THE DRAWINGS

FIG. 1 illustrates a schematic of a fourth-order ladder sub-circuit;

FIG. 2 illustrates a schematic of a kladder sub-circuit;

FIG. 3 illustrates a lateral rc sub-circuit connecting two rcc sub-circuits;

FIG. 4 illustrates a 3-port sub-circuit implemented with the first order serial resistor-inductor topology;

FIG. 5 illustrates a schematic of a two-conductor three-segment T-Line sub-circuit;

FIG. 6a illustrates a cross-section of a MIM cap;

FIG. 6b illustrates an equivalent circuit model for the MIM cap;

FIG. 7 illustrates two paths merged in series into a single path;

FIG. 8 illustrates a flow chart for EM-graph generation and consolidation in accordance with an embodiment of the present invention;

FIG. 9 illustrates a flow chart for automatic generation of a network of modeling elements mapped from the EM-graph in accordance with an embodiment of the present invention;

FIG. 10 illustrates a flow chart for automatic generation of a network of modeling elements based on a specific mapping strategy in accordance with an embodiment of the present invention;

FIG. 11 illustrates a flow chart for a proposed optimization strategy in accordance with an embodiment of the present invention;

FIG. 12 illustrates a flow chart for automatic optimization strategy for inductors and transformers without particular design intentions; and

FIG. 13 illustrates a comparison between a Flexible-PBM optimization strategy (left-side) and a fixed PBM optimization strategy (right-side) in accordance with an embodiment of the present invention.

### DETAILED DESCRIPTION

### Basic Modeling Elements

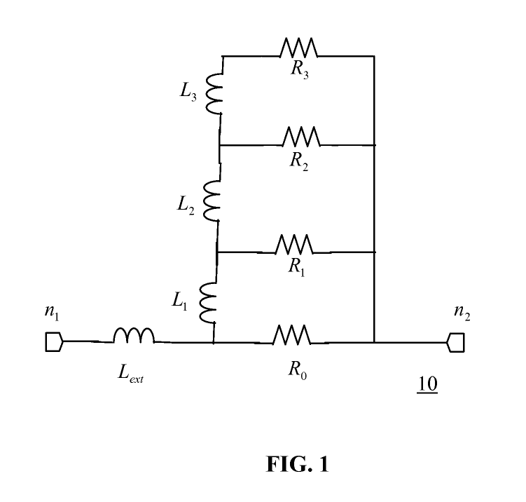

Skin effect, proximity effect, substrate-to-ground loss and the leakage through substrate are electromagnetic effects critical to today's RF and high-speed IC designs. Each of those effects can be predicted by a modeling element composed of a few lumped RLCK elements Skin effect is the tendency of an alternating electric current (AC) to distribute itself within a conductor so that the closer of the current to the surface of the conductor the higher the current density. The skin effect causes the effective resistance of the conductor to increase with the frequency of the current. Skin effect is usually associated with a conductive path and its circuit behavior is predicted by a ladder sub-circuit. FIG. 1 illustrates a fourth-order ladder circuit 10.

Given a ladder sub-circuit of any order, the branch impedance is a function of frequency and a few other variables:

Zₛₑᵣᵢₐₗ(f)=Z(f;n,L_{dc},R_{dc},L₁,R₁) (1)

Here, L_{dc} and R_{dc} are the serial DC inductance and resistance respectively; n is the order of the model. The higher the order, the stronger the skin-effect it can possibly represent at the cost of the higher complexity of the sub-circuit; Lₑₓₜ, L₁, R₁ are parameters which can be adjusted for a better fit of the desired frequency-dependent impedance curve while at the same time constant serial DC inductance and resistance are maintained.

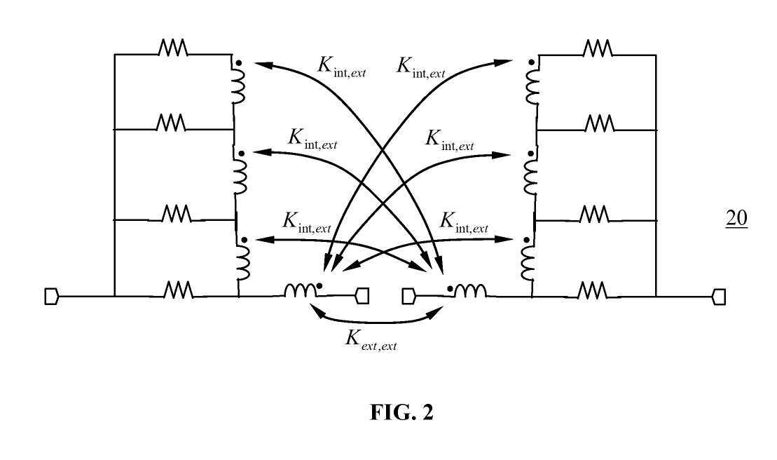

The proximity effect refers to the phenomenon that the current distributions in nearby conductors are mutually influenced by the alternating magnetic field generated by these currents. The proximity effect significantly increases the AC impedance of adjacent conductor. The proximity effect between two adjacent conductive paths, each of which is modeled with a ladder, is predicted by a kladder sub-circuit 20 shown in FIG. 2. K_{ext,ext} is the inductive coupling coefficient between two Lₑₓₜ and K_{int,ext} is the inductive coupling coefficient between Lₑₓₜ of one ladder and any “internal” inductor of the other ladder. The inductive coupling coefficient is defined such that the mutual inductance can be represented as

M=K*\sqrt{L₁·L₂} (2)

The two inductive coupling coefficients K_{ext,ext} and K_{int,ext} are related through the following equality

V(K_{ext,int},K_{ext,ext}, x̅₁, x̅₂)≡Vᵢ(f₀) (3)

Here, Vᵢ(f₀) is the voltage across one ladder branch induced at a fixed low frequency f₀ by per unit current flowing through the other ladder branch; x̅_{i=1,2} is the set of all parameters of i-th ladder. This equality must always be satisfied in order to maintain constant the total DC inductance of two cascaded coupled conductive paths.

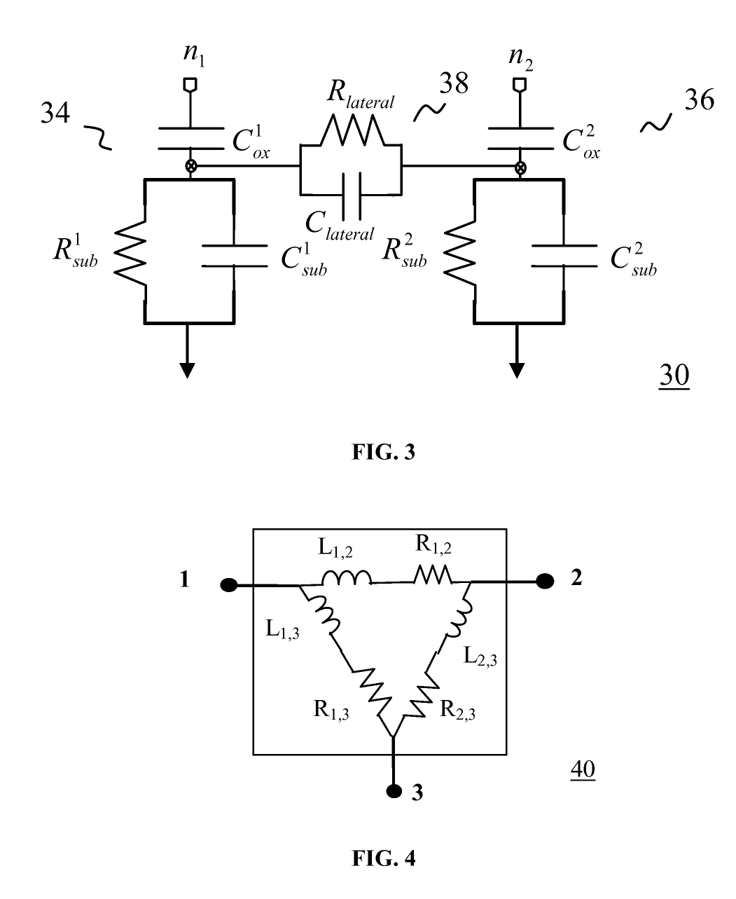

The electric field generated from conductors can penetrate into the lossy substrate and cause loss to ground and loss through substrate. FIG. 3 illustrates an equivalent model circuit 30 that generally models the effect of the generated electric field from the conductors. As shown in FIG. 3, the substrate-to-ground loss effect is commonly modeled with an “rcc” (Resistor-Capacitor-Capacitor) sub-circuit (34, 36) connecting each node to ground. The loss through the doped substrate is modeled with a “lateral rc” sub-circuit 38 which connects between the two rcc sub-circuits (34, 36).

Since currents can branch in a junction area, an N-port type of sub-circuit is introduced. An N-port sub-circuit connects to external sub-circuits through N ports. Internally, it may be implemented with any possible circuit that can work together with all other external sub-circuits to maintain the DC resistance and inductance among the ports of the entire structure. A three-port sub-circuit with the simplest first-order serial resistor-inductor network 40 is shown in the FIG. 4. N-port sub-circuits implemented with more complicated topology can help to improve the overall modeling accuracy, but are usually difficult to design and can be costly to apply in the circuit simulation.

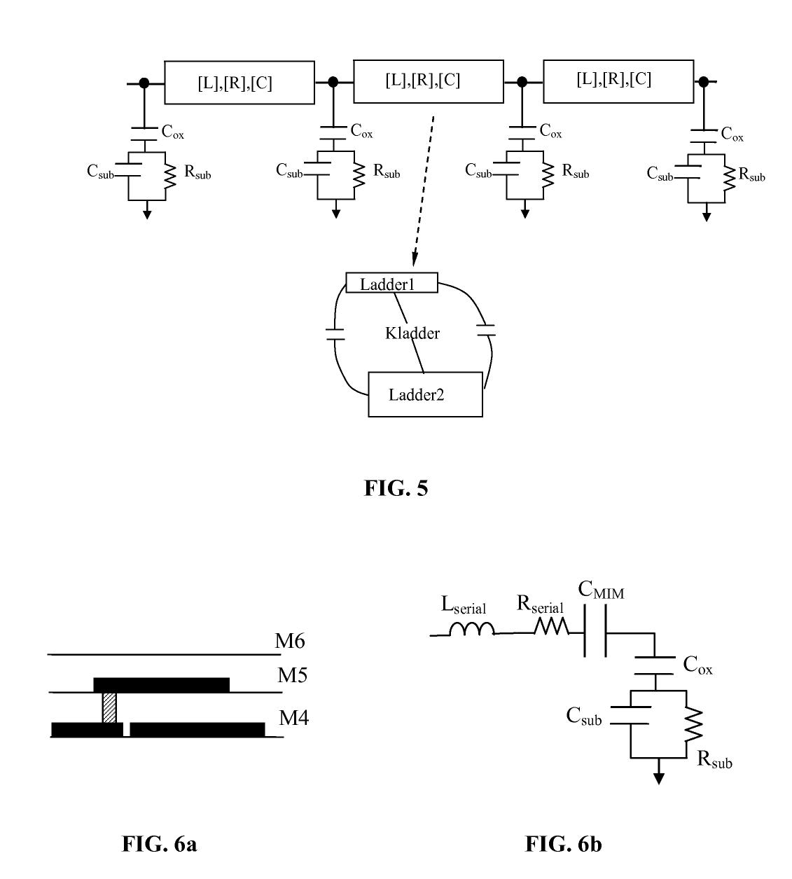

New basic modeling elements can be introduced by networking existing basic modeling elements. For example, a T-Line element can be added to a library of basic modeling elements to model any group of multiple long parallel wires with fixed widths, which resembles uniform multi-conductor transmission lines. Referring to FIG. 5, a two-conductor three-segment T-Line sub-circuit has three cascaded identical segments, each of which consists of two ladders coupled through capacitors and a kladder.

### Model Topology Construction

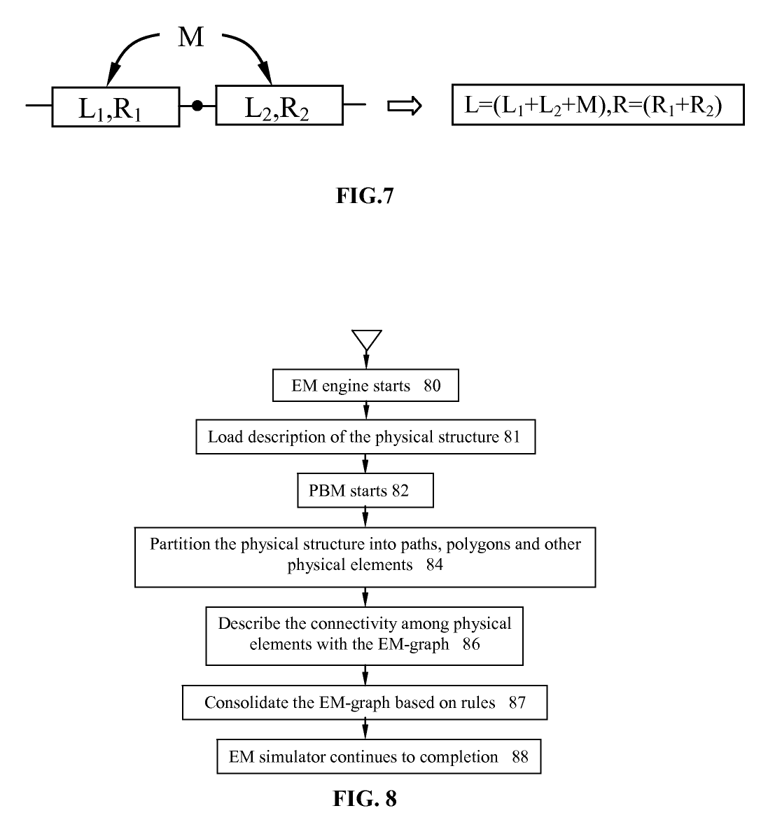

Prior knowledge and physical insights can be applied to the designs of some well-understood components in the form of appropriate topologies for the network of modeling elements. FIG. 6a illustrates a cross-section of a MIM (Metal-Insulator-Metal) capacitor. FIG. 6b illustrates a generally accepted topology for the equivalent network of modeling elements. For general structures, a systematic method can be used to generate a topology of networked modeling elements automatically. The approach begins with constructing a physical topology by partitioning the physical structure into physical elements such as paths and polygons and describing the connectivity among those physical elements with a graph termed as “EM-graph”. Inside the EM-graph, a connection between any two physical elements is made through a virtual node. All connected physical elements form an island. An EM-graph can have one or more islands. Any two distinct islands are not connected. A set of rules are applied to consolidate the EM-graph to obtain good balance between modeling cost and modeling accuracy while maintaining all mandatory DC constraints. A probe is then created for each virtual node of the consolidated EM-graph and passed to EM simulator. EM simulator produces not only simulation data but also auxiliary information which aids the optimization process. The auxiliary information is obtained through the probes. The introduction of probes does not disturb the process of generating EM simulation data. FIG. 7 illustrates one possible rule which merges two paths in series into a single path and how serial DC resistance and inductance are maintained after the merge.

FIG. 8 illustrates an example of a flow chart of EM-graph generation and consolidation. After EM simulator starts at 80 and loads description of the physical structures at 81, PBM begins at 82. Partition the physical structure into paths, polygons and other physical elements at 84. Describe the connectivity among physical elements with the EM-graph at 86. Consolidate the EM-graph based on rules at 87. EM simulator continues work until completion at 88. Based on the EM-graph and mapping strategy, paths, polygons, nodes, and couplings between paths and polygons can be mapped into appropriate modeling elements to form the topology of the network for the whole structure. The initial values of the parameters of those modeling elements can be either retrieved from simulation data as well as the auxiliary information or through EM simulation of corresponding physical elements at DC or a low frequency. According to an embodiment of the invention, the mapping process can be concurrent in that multiple modeling elements can be created, initialized, and added to the network concurrently.

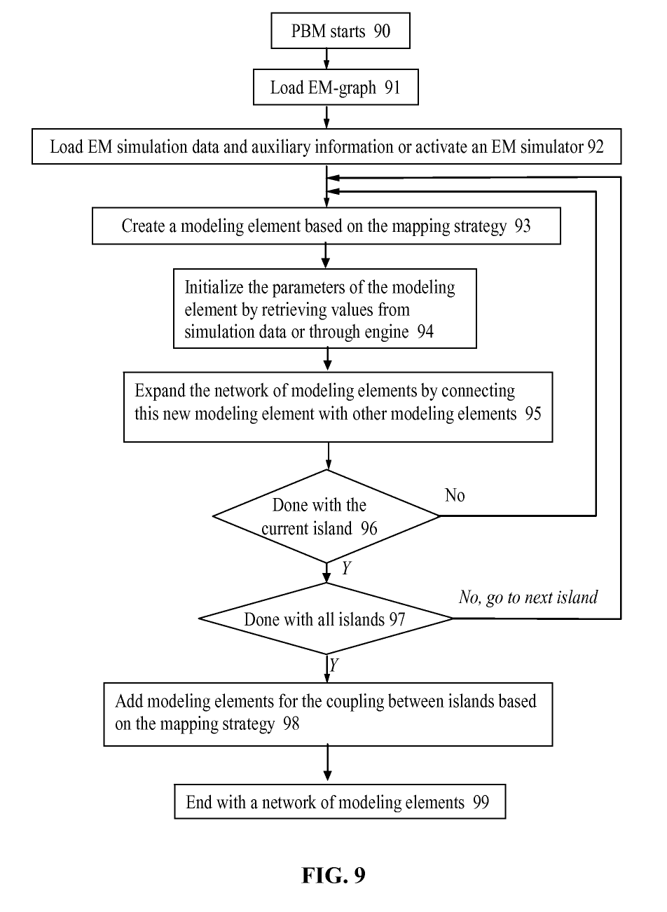

FIG. 9 shows the flow of automatic generation of a network of modeling elements using an EM-graph. After EM simulation is completed, PBM begins at 90. Load EM-graph is performed at 91. Load simulation data and the auxiliary information or activate an EM simulator at 92. Next, the flow creates a modeling element based on the selected mapping strategy at 93. Examples of mapping strategy include mapping each path to a ladder, mapping each node to a rcc sub-circuit, or mapping the magnetic coupling between each pair of paths to a kladder, etc. Parameters of the modeling element are initialized by retrieving values from either the simulation data and auxiliary information or though an EM simulation at 94. Network of modeling elements are expanded by connecting the new modeling with other modeling elements at 95. At decision 96, if the automatic generation of a network is done with the current island, the flow moves to 97 otherwise, the flow returns to 93 for creation of additional modeling elements. At 97, if the EM-graph generation is done with all islands, flow continues to 98, otherwise the flow returns to 86 and moves to another island for creation of modeling elements. At 98, modeling elements are added for the coupling between islands based on the mapping strategy. The EM-graph generation is complete with the network of modeling elements at 99. Different mapping strategy can result in different networks of modeling elements. An example of pseudo-code for generating a network of modeling elements in accordance with the present invention is provided in Appendix.

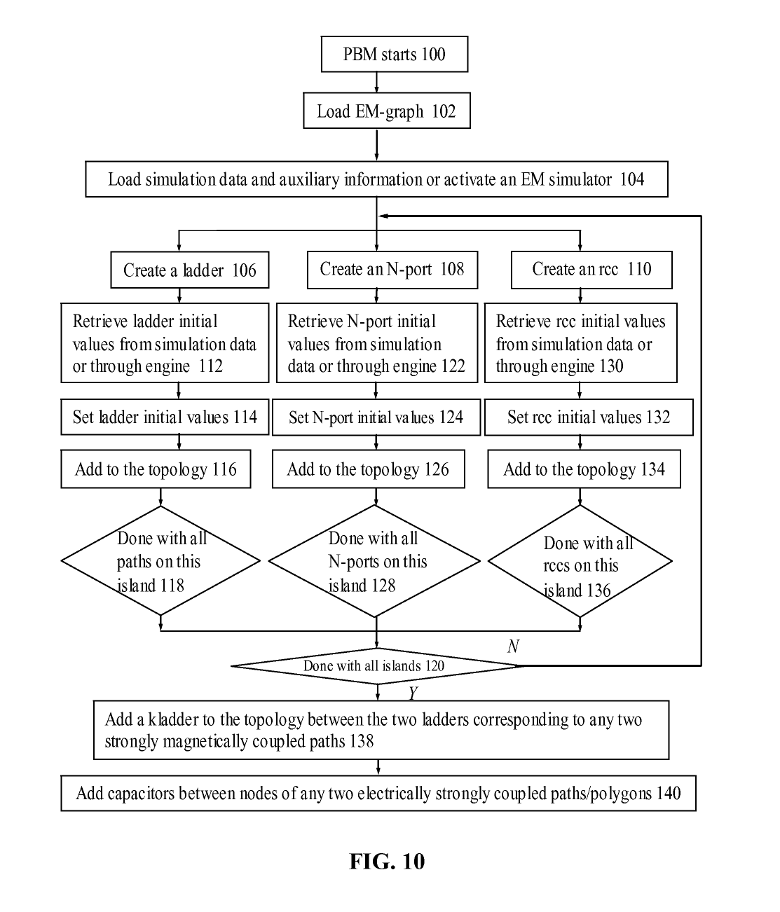

FIG. 10 shows the flow of automatic generation of the network of modeling elements based on a specific mapping strategy. PBM begins at 100 and EM-graph loads at 102. At 104, load simulation data and auxiliary information or activate an EM simulator occurs. Create a ladder occurs at 106, create an N-port occurs at 108; and create an rcc occurs at 110. Create a ladder begins with retrieving ladder initial values from simulation data and auxiliary information or through EM simulation of the corresponding physical element at DC or a low frequency at 112. Next flow moves to set ladder initial values at 114 and add to the topology at 116. Decision 118 determines if all paths on this ladder is complete. If all paths are not complete, flow returns to create a ladder 106 via decision done with all islands at 120 until all paths are complete. At 120, if not done with all islands, flow returns to another island at 106, 108, or 110. Moving down create an N-port at 108, retrieve N-port initial values from simulation data or through EM simulation of the corresponding physical element at DC or a low frequency is performed at 122. Set N-port initial values occur at 124; and add to the topology occurs at 126. Decision 128 determines if all N-ports on this island is complete, if not, flow continues back to create an N-port until all N-ports are complete via decision block 120 done with all islands being not true. Moving to create an rcc at 110, retrieve rcc initial values from simulation data or through EM simulation of the corresponding physical element at DC or a low frequency performs at 130. Set rcc initial values occur at 132, and add to the topology occurs at 134. Decision 135 determines if all rccs on this island is complete, if not flow returns to create an rcc via decision at 120 with done with all islands being not true. Once decision at 120, done with all island is true, flow moves to add a kladder to the topology between the two ladders corresponding to any two strongly magnetically coupled paths at 138. Next, add capacitors between nodes of any two electrically strongly coupled paths/polygons at 140 to complete the automatic generation of a network of modeling elements.

### Optimization Strategy

The design intention determines the performance targets that are captured closely in the frequency range of interest by adjusting the parameters of the modeling elements in the network. According to an embodiment of the present invention, optimization can generally be formulated as the following non-linear least square problem with bounded constraints:

$${\overline{χ}}^{*} = argmin {\sum }_{i} {w}_{i} {‖ {ξ}_{i}^{*} ( \overline{f} ) - {ξ}_{i} ( \overline{f} , \overline{χ} ) ‖}_{2}^{2} , s . t . {\overline{χ}}_{l} \leq {\overline{χ}}^{*} \leq {\overline{χ}}_{u} \qquad ( 4 )$$

Here, f̅ is a vector of simulation frequencies; ξᵢ*( f̅) is the i-th performance target; ξᵢ( f̅, χ̅) is the objective function for the i-th performance target, which is generally not convex; wᵢ is the weight associated with the i-th performance target; χ̅* is the solution which is subject to a lower bound χ̅ᵢ and an upper bound χ̅ᵤ.

A general way to solve problem (4) with any non-linear programming method is deemed neither effective nor efficient: it is well-known that the success of “local” nonlinear programming methods a.k.a gradient-based methods depends heavily on good initial guesses. Different performance targets are sensitive to different sets of parameters and different physical effects become pronounced in different frequency ranges. Combining all performance targets in a brutal-force way and minimizing them against all parameters across a universal frequency range increase the risk of being trapped into a unfavorable local minimum since initial guesses are usually not good enough, and at the same time waste the computational resources unnecessarily. The total number of all parameters increases quickly with the structure getting more complicated and can make the application of global nonlinear programming methods computationally intractable.

According to an embodiment of the invention, the problem can be resolved using a divide-and-conquer strategy which embeds a sequence of non-linear programming tasks into a frequency-continuation scheme.

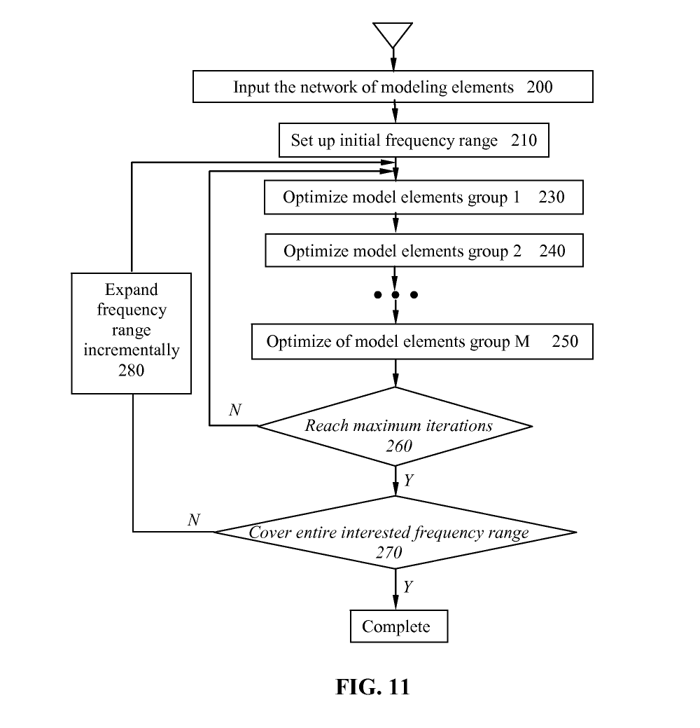

FIG. 11 illustrates a flow chart of an optimization strategy according to an embodiment of the present invention. The flow begins with input the network of modeling elements at 200. Set up initial frequency range at 210. Next, model elements of groups 1, 2, . . . M are optimized at 230, 240, and 250, respectively. At 260, if maximum iterations are not reached, the flow loops back to 230. If maximum iteration is reached at 260, the flow moves to external loop 270 which determines if entire interested frequency range is covered. If not, flow returns to 230. If yes, optimization is complete. The external loop 270 increases the initial frequency range incrementally until it covers the entire interested frequency range. Incrementally increasing the frequency aides convergence as the results from the preceding frequency range are generally good initial guesses for the current frequency range. Inside the frequency loop 260, problem (4) is divided into multiple optimization tasks. Each task has a particular performance target against a specific set of modeling element parameters over the intersection of the frequency range of each task and the frequency range in the external loop. The parameters and frequency range is determined so that the performance target is sensitive to the parameters within the frequency range over all other modeling parameters. The influence of the preceding steps is taken into account since the most up-to-date values of all parameters are used in the evaluation of current objective function. Inner loop usually converges within two iterations.

When design intention is not provided, the EM-graph can be analyzed to deduce some useful design hints which often lead to reasonable performance targets. For example, since the major path of each island, which is defined as the dominant path among all possible paths connecting any two ports of the island, is usually among main signal paths for the design, performance targets associated with those major paths such as differential Q-factor and resistance usually characterize the design to a good extent either directly or indirectly. Extending the idea further to multiple islands, performance targets can be designed to capture strong couplings between major paths of any two islands, as those couplings tend to have much bigger impact on main signal paths than any other couplings. Auxiliary optimization steps which involve an individual basic modeling element, such as a ladder or an rcc, are also often introduced to prepare good initial values for subsequent optimization of performance targets tied to the design hints, which are generally more expensive since more modeling elements are involved.

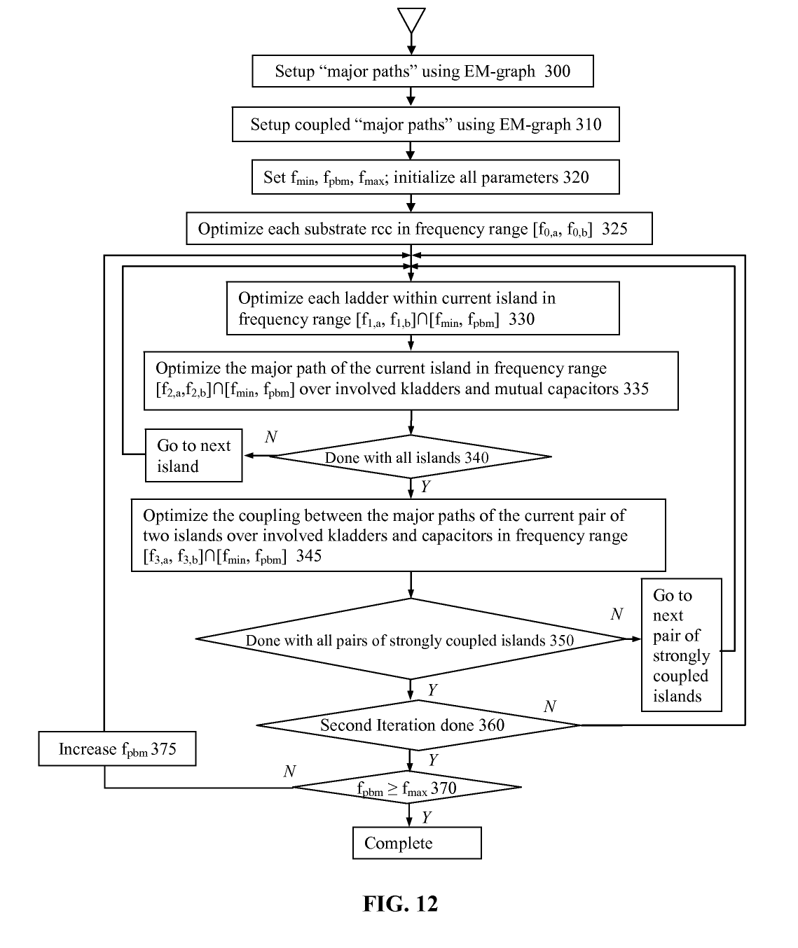

FIG. 12 shows an automatic optimization strategy which has been successfully applied to inductors and transformers using the described design hints in accordance with an embodiment of the present invention. The flow begins with setup major paths using EM-graph at 300. Setup coupled major paths using EM-graph at 310. Next, set fₘᵢₙ, f_{pbm}, fₘₐₓ; initialize all parameters at 320. Next, optimize each substrate rcc in frequency range [f0,a, f0,b] at 330. Optimize each ladder within current island in frequency range [f_{1,a}, f_{1,b}]∩[fₘᵢₙ, f_{pbm}] at 335. If not done with all islands at 340, return to 330 and go to next island. If done with all islands at 340. Optimize the coupling between the major paths of the current pair of two islands over involved kladders and capacitors in frequency range [f_{3,a}, f_{3,b}]∩[gₘᵢₙ, f_{pbm}] at 345. If not done with all pairs strongly coupled islands at 350, return to 330 and go to next pair of strongly coupled islands. If done with all pairs of strongly coupled islands, move to 360 and determine if second iteration is done. If second iteration not done, return to 330. If second iteration is done at 360, flow move to 370. At 370, if f_{pbm}≧fₘₐₓ increase f_{pbm} at 375 and goto 330. If if f_{pbm}≧fₘₐₓ is true, the automatic optimization strategy is complete.

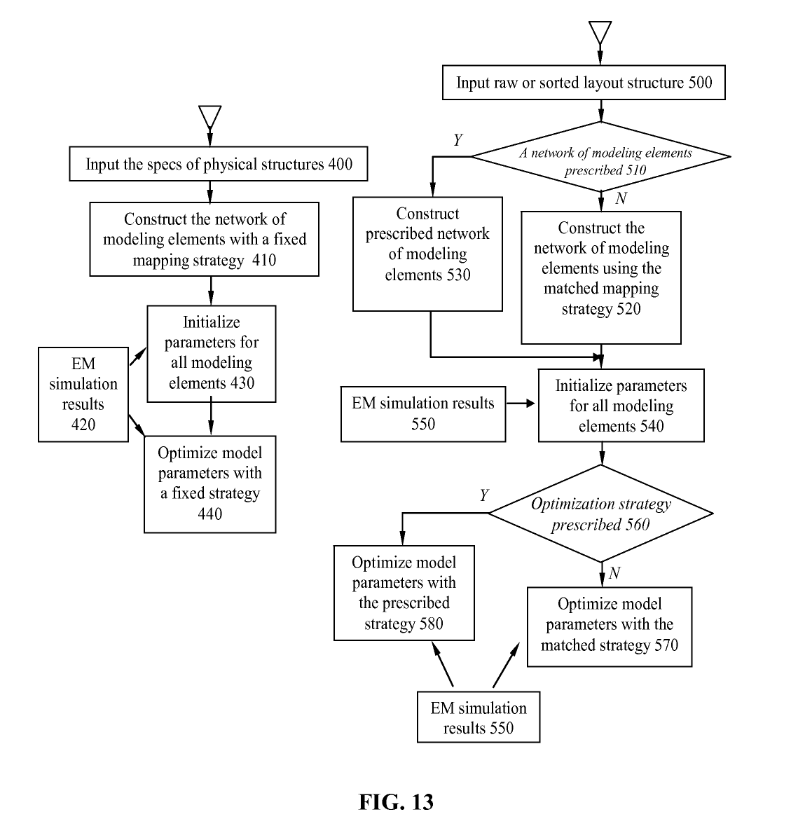

FIG. 13 compares flexible PBM flow with fixed PBM flow. The flexible PBM flow is illustrated on the left side, and the fixed PBM flow is on the right side of FIG. 12. Beginning with the fixed PBM flow at 400, input the specs of physical structures. Next, construct the network of modeling elements with a fixed mapping strategy at 410. Based on the EM simulation results 420, initialize parameters for all modeling elements at 430 and optimize model parameters with a fixed strategy at 440. The flexible PBM flow begins with input raw or sorted layout structure at 500. If a network of modeling elements is not described at 510, construct the network of modeling elements using matched mapping strategy at 520. If a network of modeling elements is described at 510, construct prescribed network of modeling elements at 530. Next, initialize parameters for all modeling elements at 540 based on EM simulation results 550. At 560, if optimization strategy is not prescribed, optimize model parameters with the matched strategy at 570 based on EM simulation results 550 and the fixed PBM flow ends. If at 560, optimization strategy is prescribed, optimize model parameters with the prescribed strategy at 580 based on the EM simulation results at 550 and the fixed PBM flow ends.

### Flexible PBM

As disclosed in the above, the success of the proposed modeling methodology hinges on two key elements: an appropriate network of modeling elements to adequately model the dominant physical effects and a well-designed optimization strategy to adjust the parameters of the modeling elements to capture the underlying physical effects effectively. A straightforward implementation of the proposed methodology is to use a fixed mapping strategy and a fixed optimization strategy.

To take full advantage of the proposed methodology, Flexible PBM evolved as a highly extensible and flexible physics-based modeling framework. The flexible PBM excels compared to previous techniques by enabling unmatched flexibility in both key elements. The foundation of the modeling framework can be built in any high-level language such as Python. In addition to some predefined modeling methods each of which is a combination of certain predefined mapping strategy and optimization strategy, APIs are provided for customizing the network of modeling elements and the optimization strategy, which involves the design of both performance targets and the corresponding subset of parameters. The network topology, so-called “top-cell”, is described as a collection of interconnected “sub-cells”. Sub-cells are basic modeling elements which are either lumped RLCK elements or sub-circuits. Users can create new basic modeling elements since sub-cells all share a standard interface. Properties like symmetry between sub-circuits can also be enforced by advanced users. So a topology can be customized with a description of a top-cell hierarchically built with basic modeling elements. The customization of optimization strategies is further supported through the definition of a modeling function which takes a list of parameters and executes a sequence of optimization steps. The flexibility brought by Flexible PBM enables modeling experts to codify their knowledge and deploy to designer community for use. Since the process, modeling and physical knowledge can all be encapsulated, designers can concentrate on circuit designs instead of process details; the Flexible PBM provides a great tool for circuit designers to improve and enhance their ability to predict and simulate the challenges of passive-modeling tasks.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Moreover, the above disclosure is not intended to limit the present invention. The scope of the present invention is defined by the claims.

```
APPENDIX
Start PBM
Load EM-graph
Load EM simulation data and auxiliary information
Create an empty network of modeling elements
For the i-th island of the EM-graph, i from 1 to N. N is the total number
of islands
    For each path of the i-th island
        Map to a ladder
        Initialize the ladder
        Insert the path into the network
    End
    For each node of the i-th island
        Map to a rcc
        Initialize the rcc
        Insert the path into the network
    End
End
For the i-th island, i from 1 to N
    For the j-th island, j from i+1 to N,
        For the s-th ladder of the i-th island
            For the t-th ladder of the j-th island
                Map the coupling between s-th ladder of the i-th
island and t-th ladder of the j-th island to a kladder
                Initialize the kladder
                Insert the kladder into the network
            End
        End
    End
End
```

We claim:

1. A method for electrical modeling of passive structures of a circuit design wherein the passive structures have DC properties, comprising the steps of:
constructing a physical topology based on the passive structures of the circuit design;
mapping the physical topology to a network of EM modeling elements; and
determining parameters of the EM modeling elements to model the passive structures based on electromagnetic simulation data.

2. The method of claim 1, wherein in the step of determining parameters of the EM modeling elements is determined by using a sequence of optimizations based on the electromagnetic simulation data.

3. The method according to claim 1, wherein the step of constructing physical topology includes the substep of generating an EM-graph comprising of one or more islands.

4. The method of claim 3, wherein the islands are each comprised of paths, polygons, and virtual nodes.

5. The method according to claim 4, wherein the virtual nodes allow probing of auxiliary information to aid the determination step without disturbing the EM simulation data.

6. The method according to claim 1, wherein the step of constructing physical topology includes the substep of applying a set of rules to consolidate the EM-graph and maintain the DC properties of the physical structure for the consolidated EM-graph.

7. The method according to claim 1, wherein the step of mapping the physical topology includes the step of providing a library of EM modeling elements.

8. The method according to claim 1, wherein the EM modeling elements are passive, physical realizable, and each of the EM modeling element covers one or more EM effects including skin-effect, proximity effect, substrate-to-ground loss and leakage through substrate.

9. The method according to claim 1, wherein the EM modeling elements maintains the DC properties of the physical structure in the determining step.

10. The method according to claim 7, wherein the EM modeling elements use a ladder sub-circuit to model the skin effect of a conductive path, and use a kladder sub-circuit to model the proximity effects between two adjacent conductive paths each modeled as a ladder.

11. The method according to claim 1, wherein the step of determining the parameters of the EM modeling elements uses a divide-and-conquer strategy which embeds a sequence of programming tasks into a frequency-continuation scheme.

12. The method of claim 11, wherein the frequency-continuation scheme uses an internal loop which executes a sequence of multiple optimization tasks, wherein each of the tasks has a performance target, a subset of the parameters from all of the EM modeling elements, and a frequency range.

13. The method of claim of 12, wherein the performance target is designed as a function of the EM-graph.

14. The method of claim 12, wherein certain ones of the tasks is an auxiliary optimization step wherein one of the EM modeling elements is used to prepare initial values for subsequent optimization tasks.

15. The method of claim 1, wherein the network of EM modeling elements is prescribed.

16. The method of claim 15, wherein the method for determining the parameters of the EM modeling elements is prescribed.

17. The method of claim 1, wherein the method for determining the parameters of the EM modeling elements is prescribed.

18. The method of claim 1, wherein an API is provided for customizing the network of modeling elements and customizing the method for determining the parameters of the EM modeling elements.

19. The method of claim 1, wherein a high-level programming language is used in prescribing the network of EM modeling elements.

20. The method of claim 2, wherein a high-level programming language is used in prescribing the method for determining the parameters of the EM modeling elements.
